(19) United States
(12) Patent Application Publication
(10) Pub. No.: US 2009/0202764 A1
(43) Pub. Date: Aug. 13, 2009

(54) RFL film or adhesive dip coating comprising carbon nanotubes and yarn comprising such a coating

(75) Inventors: Corinne Tonon, Mirabel et Blacons (FR); Isabelle Vial, Valence (FR); Stephanie Lambour, Mions (FR)

Correspondence Address: OLIFF & BERRIDGE, PLC, P.O. BOX 320850, ALEXANDRIA, VA, 22320-4850, US

(73) Assignee: PORCHER INDUSTRIES, Badinieres (FR)

(21) Appl. No.: 12/292,839

(22) Filed: Nov. 26, 2008

Related U.S. Application Data
(60) Provisional application No. 61/071,986, filed on May 29, 2008.

(30) Foreign Application Priority Data
Nov. 26, 2007 (FR) 0759321

(51) Int. Cl. D02G 3/36; B32B 27/04; B32B 1/08; B05D 3/02; B05D 5/10; C08K 3/04; B82B 1/00

(52) U.S. Cl. 428/36.3; 428/338; 428/368; 427/385.5; 427/207.1; 524/496; 977/750; 977/752

(57) ABSTRACT

The invention relates to an RFL film or adhesive dip coating comprising carbon nanotubes.

It also relates to a yarn coated or impregnated with a coating according to the invention.

It also relates to the use of the yarn thus treated for reinforcing an article based on a rubber material, said article possibly being a belt, a tube, a hose, a pipe or a tire and generally any object subjected to shear stresses.

### TECHNICAL FIELD

The invention relates to the field of longitudinal reinforcing elements for rubber-based articles such as belts, in particular timing belts, tires for motor vehicle or similar use, or tubes, hoses or pipes and also air-cushion shock absorbers. It is more particularly directed toward a process for obtaining a reinforcing yarn that has improved properties of attachment to rubber materials, in particular in terms of longevity, heat resistance and resistance to shear stresses.

In general, the term “rubber material” will be understood hereinbelow to mean not only materials based on natural rubber (or polyisoprene) or on synthetic rubbers based especially on polychloroprene, or on hydrogenated or non-hydrogenated polyacrylonitrile, but also in a broad sense materials that have a behavior that may be termed as being rubber-like, in particular as regards their elastic properties, permitting an elongation of several times their original length, with resumption of the initial form without permanent deformation. Examples that may be mentioned include certain elastomers based on polybutadiene, polyisobutylene and polyurethanes.

### PRIOR ART

It is well known to reinforce certain rubber-based articles, in particular when they are subjected to large mechanical stresses, in order to avoid excessive elongation or even degradation thereof.

Thus, textile yarns that are capable of withstanding strong tensile stresses, in particular those whose elongation is virtually zero, are generally used as reinforcing element.

Glass yarns, carbon yarns or even aramid yarns (i.e. yarns constituted of a plurality of filaments of this material) are known to give good results.

However, these yarns must undergo adhesive dip treatments intended to improve their properties of attachment to the rubber material. Thus, it is essential for the rubber material to adhere as intimately as possible to the reinforcing yarns, in order for these yarns to perform their function.

Thus, among the adhesive dip treatments very widely used, impregnations in solutions based on resorcinol-formaldehyde resin and rubber latex, which are known for short as RFL solutions, are known.

This adhesive dip treatment may be followed by a second treatment known as a “topcoat”, which in general consists of a solution of rubber material in a solvent, known as “rubber cement”, which has the role of promoting the attachment of the rubber that constitutes the article to the yarn bearing its adhesive dip coating.

In certain cases, the RFL solution may include a certain proportion of carbon black, typically up to 10%. These carbon black particles act as filler and improve the mechanical strength of the impregnation that covers the textile fibers, see, for example, the formulations described in Application WO 02/055590.

Generally, the use of carbon nanotubes for improving the attachment of coatings to fibers and their use in composites such as, for example, in the epoxy resin composites described in WO 2005/028174 is known. Apart from the nanotubes possibly being functionalized, these composites are not subjected to the same mechanical stresses, especially the shear stresses to which the belts, for example, or the tubes or hoses are subjected.

Regarding, more particularly, belts, it is known from JP 2003/322216, in order to improve the friction resistance of a toothed belt, to use nanotubes that are added to the rubber cement in a solvent or topcoat, said rubber cement being coated onto a fabric previously impregnated by an adhesive dip treatment.

However, when the composite article is subjected to large mechanical stresses, for example in traction, flexure or counter-flexure, the interface between the yarn, on the one hand, and more specifically its coating, and the rubber material, on the other hand, undergoes shear stresses. Degradation of the integrity of the coating covering the yarn and the various interfaces present in the material inevitably leads to the appearance of sliding phenomena between the yarn and the rubber material. These phenomena are proportionately more numerous the higher the mechanical stresses.

Working at high temperature is also a factor that degrades the integrity of the coating of the yarn and the interfaces between materials.

The prior art treatments described above, although they make it possible to improve the attachment between the rubber and the adhesive dip coating, do not, however, make it possible to improve the dynamic mechanical properties of this RFL film or adhesive dip coating. The weaknesses observed when subjecting the articles thus reinforced to high mechanical stresses are thus due to the weaknesses of the RFL film or adhesive dip coating.

One of the objects of the invention is to improve the mechanical properties, in particular the dynamic mechanical properties, of the RFL film or adhesive dip coating in order to increase the service life of the composite article.

Another object is to improve the strength over time of the mechanical adhesion properties between the reinforcing yarn and the rubber material. Another object is to allow functioning at higher temperatures without degradation of its mechanical properties.

### DESCRIPTION OF THE INVENTION

The invention thus relates to a yarn-based longitudinal reinforcing element intended to be incorporated into a rubber-based article. The term “yarn” means yarns constituted by the assembly of multiple filaments, but also single-strand yarns or monofilament yarns. These yarns may be used in their native form, or alternatively after assembly with yarns of similar or different nature, via cabling and/or twisting operations.

In a known manner, this yarn comprises an adhesive dip coating that is in accordance with the invention, this coating includes carbon nanotubes.

According to the aforementioned information, the carbon nanotubes are conventionally added to compositions comprising solvents.

The RFL film or adhesive dip coating is itself composed of an aqueous composition comprising a resorcinol-formaldehyde resin and rubber material latex.

The incorporation of carbon nanotubes into such a composition at basic pH without deteriorating the latex and while obtaining a homogeneous suspension of nanotubes is a problem that has been solved by the present invention.

The invention relates more particularly to an RFL film or adhesive dip coating comprising carbon nanotubes.

It relates to a coating according to the invention, characterized in that it comprises a mixture of rubber latex and resorcinol-formaldehyde resin.

It relates to a coating according to the invention, characterized in that it comprises from 0.5 to 10% by weight of carbon nanotubes, as solids.

It relates to a coating according to the invention, characterized in that the nanotubes are of single-walled or multi-walled type.

It relates to a coating according to the invention, characterized in that the nanotubes have an average diameter between 1 and 100 nanometers.

It relates to a coating according to the invention, characterized in that the nanotubes have an average diameter between 1 and 30 nanometers.

It relates to a coating according to the invention, characterized in that the nanotubes are completely or partly functionalized.

It also relates to a yarn coated or impregnated with a coating according to the invention.

In one embodiment, the yarn is chosen from the group comprising glass yarns, carbon yarns, aramid yarns, polyester yarns, polyvinyl alcohol yarns, polyamide yarns and rayon yarns.

It relates to said yarn comprising, in addition, a coating or topcoat based on a rubber cement in a solvent that may or may not comprise carbon nanotubes.

It also relates to the use of yarns thus treated for reinforcing an article based on a rubber material, said article possibly being a belt, a tube, a hose, a pipe or a tire and generally any article subjected to shear stresses.

It also relates to a longitudinal reinforcing element based on yarns according to the invention, intended to be incorporated into an article based on a rubber material.

It also relates to the process for preparing said RFL film or adhesive dip coating and its method of application to the yarns.

The term “carbon nanotube” means particular crystalline structures, of tubular shape, composed of regularly arranged carbon atoms, also known as tubular fullerenes.

In other words, the layer of RFL film or adhesive dip coating that covers the yarn includes particles of thread-shaped structure, of small diameter, typically of the order of a nanometer, with regard to their length, which is of the order of a micrometer. These thread-shaped structures act, so to speak, as armoring for the coating layer that contains them, and thus improve the mechanical strength of this layer.

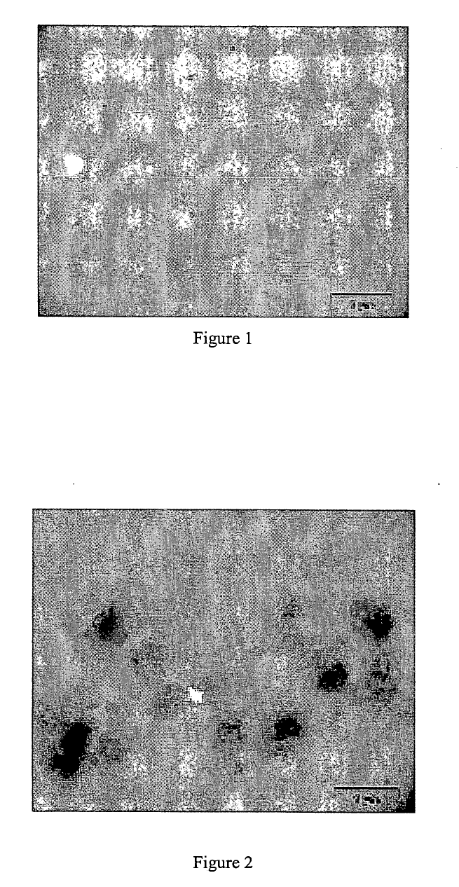

Thus, when compared with solutions including fillers such as carbon black, the integrity of the coating is improved by virtue of the intermeshing of the molecular chains of the polymers of the coating matrix with the chains formed by the nanotubes, see FIGS. 1 to 4, which are transmission electron microscopy (TEM) photographs of RFL fibers.

FIG. 1 is a TEM photograph of an unfilled RFL.

FIG. 2 is a TEM photograph of an RFL filled with 2% of nanotubes.

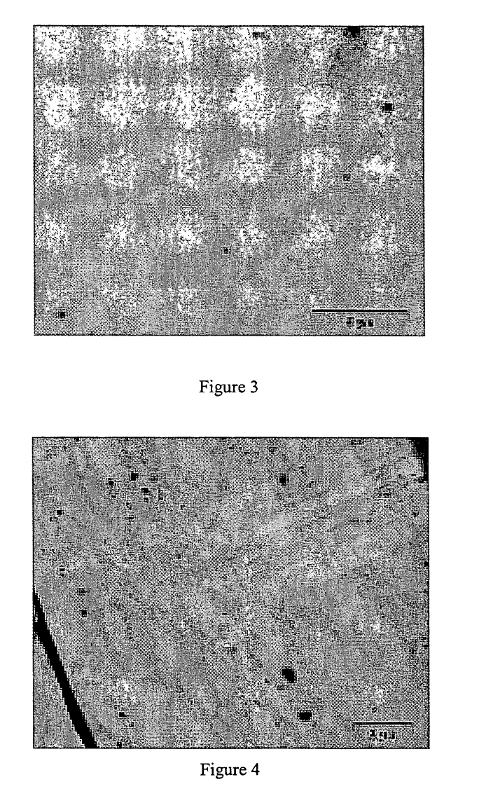

FIG. 3 is a TEM photograph of an RFL filled with 2% of nanotubes.

FIG. 4 is a TEM photograph of an RFL filled with 5% of nanotubes.

In practice, these carbon nanotubes may be present in the coating layer or the other coating layers, as a function of the desired application.

Thus, the carbon nanotubes may be embedded in the RFL film or adhesive dip coating.

It is also possible to include carbon nanotubes in the outer coating layer, which itself covers the RFL film or adhesive dip coating. This outer coating layer is generally an adhesive in solvent medium, for example a mixture of optionally halogenated polymers or of organic compounds such as isocyanates. In other words, the outer layer or “top coat” that covers the yarn comprising the RFL film or adhesive dip coating may also comprise nanotubes that improve its thermomechanical behavior and its longevity and its attachment properties with the rubber material that constitutes the reinforced article.

In practice, the yarns chosen to form the reinforcing yarns may be glass yarns, carbon yarns, aramid yarns or yarns of other synthetic materials such as polyvinyl alcohol (PVA), polyester, rayon or polyamide. These yarns may comprise filaments of homogeneous composition, or may include a mixture of filaments of different nature. These yarns may be used individually or may be assembled with similar or different yarns, via cabling and/or twisting operations.

The content of carbon nanotubes is around 0.5 to 10% by weight of carbon nanotubes, a proportion measured as solids in the RFL film or adhesive dip coating.

Satisfactory results have been obtained with a proportion of 2% nanotubes. Specifically, an excessively low proportion of nanotubes does not generate a significant reinforcing effect. Conversely, an excessive presence of carbon nanotubes may lead to the formation of agglomerates of nanotubes and the formation of large particles that give rise to points of weakness.

In general, depending on the desired applications, the carbon nanotubes used may be of monolamellar or multilamellar type. These are, respectively, tubular structures comprising a single layer of atoms arranged as a single cylinder, or as several coaxial cylinders.

Advantageously, in practice, the nanotubes have a mean length of between 1 and several hundred micrometers, for a diameter of between 1 and 100 nanometers, and preferentially between 1 and 30 nanometers. By way of example, satisfactory results have been obtained with nanotubes whose inside diameter is in the region of 5 nm for an outside diameter of between 10 and 20 nanometers.

The invention relates to the process for preparing the RFL coating, said process comprises:
a step of preparing the RFL composition;
a step of preparing a dispersion of carbon nanotubes;
a step of mixing, by introducing the dispersion into the composition, in order to obtain a suspension; and
finally, a step of coating, impregnating or depositing the suspension obtained after mixing onto a yarn.

The RFL composition is prepared according to processes known to a person skilled in the art by mixing resorcinol or a resorcinol-formaldehyde resin in water with a suspension of a latex in water at basic pH, said basic pH being obtained by addition of ammonia. The composition obtained by mixing optionally being left to mature for around 48 h at ambient temperature.

Advantageously, in practice, in the solution of resorcinol-formaldehyde and latex (RFL), the fraction of resorcinol-formaldehyde resin represents from 2 to 30% by dry weight, the fraction of latex representing from 70 to 98%.

Preferably, the fraction of resorcinol-formaldehyde resin represents from 5 to 10% by dry weight, the fraction of latex representing from 80 to 95%.

When the yarns are intended to be embedded in rubber for producing belts, the latex used may advantageously be hydrogenated and carboxylated acrylonitrile-butadiene rubber (X-HNBR), hydrogenated acrylonitrile rubber (HNBR), acrylonitrile rubber (NBR), ethylenepropylene-diene (EPDM), chlorosulfonated polyethylene (CSM), or even vinylpyridine/styrene-butadiene rubber (VP/SBR) or styrene-butadiene rubber (SBR), taken alone or as a blend. When the yarns obtained are intended to reinforce tires, the latex used may be vinylpyridine/styrene-butadiene rubber (VP/SBR), styrene-butadiene rubber (SBR), natural rubber (NR) latex, taken alone or as a blend.

The dispersion of nanotubes is obtained by adding, under very high stirring, nanotube powder into water containing a surfactant.

The very high stirring is obtained by using a stirrer that causes a shear rate of greater than 20 000 rpm.

One important step of the manufacturing process consists in obtaining a suspension in which the nanotubes are, as far as possible, individually dispersed and dissociated from each other. In other words, it is sought to eliminate or at least to minimize the size of the agglomerates of nanotubes in which the thread-shaped molecules are assembled and intermeshed with each other.

Various processes may be used to ensure the dispersion of the nanotubes in the suspension.

It is thus possible to proceed via very high-shear mixing, or alternatively via techniques of exposure to ultrasound or the combination of these two techniques.

In certain cases, it may be useful to use surfactants that make it possible to a certain extent to keep the nanotubes separate from each other, so as to obtain agglomerates of small size, typically less than a few microns. Various types of surfactant may be used depending on the suspension containing the nanotubes, and on the other components in suspension.

Examples that may be mentioned include anionic, cationic or neutral surfactants, and also nonionic or amphoteric surfactants, or even silicone-based, fluorinated or polymeric surfactants.

It will be preferred to use a dispersion of nanotubes having a neutral or basic pH, which is compatible with the basic pH of the RFL solutions.

The step of mixing, by introducing the dispersion into the composition, in order to obtain a suspension, is carried out under gentle stirring, by using a stirrer that causes a shear rate of less than 300 rpm.

As already stated, these nanotubes may be included in the RFL film or adhesive dip coating and also in the rubber cement in a solvent intended to coat yarns previously coated with the RFL film or adhesive dip coating, in order to form an outer layer.

The content of carbon nanotubes is around 0.5 to 10% by weight of carbon nanotubes, a proportion measured as solids in the outer layer produced by application of the rubber cement in a solvent.

When the nanotubes are incorporated into the rubber cement in a solvent, the incorporation will be carried out according to the processes described in the prior art.

For certain applications, it may be chosen to use nanotubes that are totally or partially functionalized, i.e. which have molecules that have been grafted onto the nanotubes to give particular properties, typically in terms of chemical compatibility with certain matrices in which the nanotubes are immersed.

The step of coating, impregnating or depositing the suspension obtained after mixing onto a yarn is carried out according to the techniques known to a person skilled in the art and optionally comprises a splaying step in order to individually impregnate the constituent fibers of the yarn.

This step of coating, impregnating or depositing the suspension obtained after mixing onto a yarn is then followed by a step of drying and/or crosslinking.

In one preferred embodiment, the process according to the invention may include, after the impregnation step, and before the drying step, a step of sizing the coating. This sizing allows the excess solution that was entrained during impregnation to be removed.

After sizing, the fiber retains only a small amount of the RFL solution, the superfluous amount thus being removed. The subsequent drying of the fiber takes place only for the optimum amount of RFL solution.

In practice, the coating may be sized by passing the fibers through a die. Passing them through a die furthermore makes it possible to assemble the various filaments if they remain separated after impregnation. Furthermore, passage through a die allows the solution to be pressed into the fiber and ensures better impregnation at the core. The fiber obtained on leaving the dye is more round, which proves to be beneficial for the subsequent operations.

The invention also covers the variants in which the coating is sized by padding or an equivalent process.

In certain particular embodiments, it may prove beneficial, after the drying step, to heat the fibers so as to be able to cure the fraction of resorcinol-formaldehyde resin/latex solution impregnated in the fibers. This curing, corresponding to crosslinking of the RFL, is carried out after the drying that had evaporated most of the water of the impregnation solution remaining on the fibers.

For the use of the yarns according to the invention in certain articles such as, in particular, timing belts, it may prove advantageous for the process according to the invention to furthermore include an additional step of impregnating the yarn, in an adhesive in a solvent medium. This step makes it possible to obtain an additional layer covering the fiber. This additional layer, forming a ring around the fiber, is particularly advantageous for ensuring good adhesion to certain types of rubber such as acrylonitrile rubber (NBR), hydrogenated acrylonitrile rubber (HNBR), carboxylated hydrogenated acrylonitrile rubber (X-HNBR), vulcanizable hydrogenated acrylonitrile rubber (ZSC), chlorosulfonated polyethylene (CSM), alkylated chlorosulfonated polyethylene (ACSM) and ethylenepropylene-diene (EPDM).

In practice, the adhesive in a solvent medium is a blend of possibly halogenated polymers, and organic compounds such as isocyanates.

### EMBODIMENTS OF THE INVENTION

### Example 1

### Preparation of the RFL Bath

The formulation comprises two mixtures (A and B), which are combined very slowly and left to mature for about 48 hours at room temperature.

Mixture A conventionally contains deionized water (126 liters), a resin such as that sold under the reference Phenolite TD 2241 by the company Dainippon Ink (22.5 kg), 30.5% formaldehyde of the brand Univar (7.1 liters) and 30% sodium hydroxide (800 ml); the whole is stirred for 10 minutes at 60 rpm at room temperature.

Mixture B contains Pliocord VP 106 latex sold by the company Eliochem (400 kg), 20.5% aqueous ammonia (31 liters) and Pliocord SB 2108 latex sold by the company Eliochem (200 kg), the whole being prestirred at 35 rpm at a temperature of between 20 and 30° C.

Finally, a wax is added to the mixture A+B, such as the wax sold under the reference S-Wax by the company Sasada Chemical Industries (31.5 kg). Deionized water may again be added to adjust the concentration.

Preparation of the Aqueous Dispersion of Carbon Nanotubes in Water

Nanotube powder such as that sold by the companies Arkema, Bayer or Nanocyl, having a particle size of greater than 100 μm, may be used. The proportions used are given below:

| | | |
|---|---|---|
| Carbon nanotube powder | 0.75 | g |
| Water | 75 | g |
| Surfactant (ammonium polyphosphate) | 0.19 | g |

The preparation is performed by introducing the surfactant into water with gentle stirring. Next, the nanotube powder is added to the water containing the surfactant, with very vigorous stirring, typically a very high shear of greater than 20 000 rpm, obtained, for example, using a machine of the Ultra-Turrax type.

This dispersion is then introduced slowly into the RFL, in the following proportions: 61 g of aqueous dispersion in 85.5 g of RFL bath (the solids content of which is 35.7%). This introduction is performed this time with low shear so as not to destructure the RFL (<300 rpm). This stirring is maintained for 30 minutes.

To characterize the effect of the invention, the solution obtained was coated onto nonwovens (PES/cellulose of 20 g/m²) which have breaking forces that are low enough to be able to observe separations due to the type of film deposited thereon. The coating conditions are as follows: doctor blade on cylinder-wedge 20-drying 1 minute at 110° C. The mechanical results obtained in traction at room temperature (100 N sensor-speed of 100 mm/minute-10 cm between small pneumatic jaws with a specimen width of 5 cm) are given below:

| Formulations | Force (N) | % gain |
|---|---|---|
| Unfilled RFL | 7.48 | |
| RFL + 2% carbon nanotubes | 10.02 | 33.93 |
| RFL + 2% carbon nanotubes + surfactant | 11.34 | 51.53 |

The gain is calculated by reporting the difference of the two forces (filled-unfilled) relative to that of the unfilled film.

An improvement in the breaking forces is observed for the filled films, and an even higher force is observed for the formulation containing the surfactant. The gain exceeds 40%. These values may be compared with tests performed on the same RFL charged with a larger amount of carbon black, for which the gains obtained at room temperature on the mechanical strengths remain lower than those obtained with a much smaller amount of nanotubes.

| | Room temperature | | Test temp. 130° C. | |
|---|---|---|---|---|
| Formulations | Force (N) | % gain | Force (N) | % gain |
| Unfilled RFL | 14 | | 9.9 | |
| RFL + 7% carbon black | 17.7 | 23.8 | 9.9 | 0.5 |

During the test at elevated temperature, the use of carbon blacks is found to degrade the properties of the RFL film.

### Example 2

The RFL chosen is different than that in the preceding example. The mixture consists of 3 preparations that are combined dropwise:
preparation A contains deionized water (61 g), 20.5% aqueous ammonia (7 g), 41% urea sold by the company Verre Labo Mula (45.5 g) and resin sold under the reference Penacolite by the company Indspec Chemical Corp. (17 g);
preparation B contains Zetpol-B latex (HNBR) sold by the company Nippon Zeon (480 g) and deionized water (52 g). Preparation A is introduced into preparation B;
finally, preparation C is added, containing deionized water (27 g) and 30% formaldehyde from the company Univar (6.7 g). The whole is left to mature at 20° C. for 12 hours.

The proportions used are the same as previously, i.e. 2% of nanotubes on a dry weight basis relative to the RFL.

The mechanical results obtained in static traction (same conditions as Example 1) are as follows, as regards the breaking forces of the films.

| | Test temperature: | | Test temperature: | |
|---|---|---|---|---|
| | ambient | | 130° C. | |
| Formulations | Force (N) | % gain | Force (N) | % gain |
| Unfilled RFL | 14 | | 9.6 | |
| RFL + 2% carbon nanotubes | 18.7 | 33.7 | 13.2 | 40 |

The filled formulations show an improvement in the mechanical properties in traction at room temperature and at 130° C.; this encourages the use of nanofillers of this type in RFL formulations in order to increase the service life of the reinforcing yarn/rubber article complex.

### Examples 3 to 5

According to the same procedures as those described in Examples 1 and 2, RFLs according to the invention were produced with the characteristics given in the following table:

| | Nature of | Nature of | RF/L |
|---|---|---|---|
| Examples | the resin | the latex | ratio |
| 3 | Penacolite | Zetpol B | 7.4%. |
| 4 | Phenolite | MIXTURE VP, | 7.8%. |
| | TD2241 | SBR | |
| 5 | Phenolite | CSM 450 | 19.5% |
| | TD2241 | | |

*NB. The percentages are given relative to the solids

In each of these formulations, a dispersion of nanotubes in proportions of 2% of nanotubes as solids relative to the RFL was added.

It emerges from the foregoing text that the reinforcing elements in accordance with the invention have the advantage of appreciably increasing the mechanical properties of the adhesion film (in flexure, shear and compression), which can improve the service life of composite articles in which they are incorporated. Specifically, in the long term, there is less degradation of the mechanical properties than with films of the prior art.

Similarly, the use of nanotubes makes it possible to improve the heat resistance when compared with similar articles. Depending on the applications, the oil bath resistance properties may also be improved.

### Example 6

### Dynamic Mechanical Thermal Analysis (DMTA)

The DMTA measurements were carried out on films that were obtained by drying at ambient temperature, then crosslinked for 3 min in an oven at 250° C. (standard method). They should have an even and constant thickness, without bubbles or defects.

The film test specimens had a constant height of 18 mm. The RFL bath is formulated with Penacolite resorcinol, formol and latex Zetpol B, and then maturated, with a ratio R/L equal to 7.4% (example 3).

The RFL bath is formulated with Phenolite TD2241 resorcinol, formol and latex MIXTURE VP, SBR and then maturated, with a ratio R/L equal to 7.8% (example 4).

The thickness of the test specimens tested varied from 0.55 to 0.64 mm for the unfilled example 3, from 0.36 to 0.40 mm for the example 3 filled with 2% of carbon nanotubes and from 0.59 to 0.76 mm for example 4.

Shear stresses at 10 and 52 Hz (frequency actually undergone by the belt) with a temperature sweep of −80° C. to 150° C. were applied.

The change in shear modulus, Coulomb modulus G′ (The shearing stress required to produce a shearing strain of unity, i.e. shearing stress/shearing strain=G′) (stiffness of the material), the loss angle (damping capacity) and the glass transition T_{g} (change from the glassy state to the rubbery state) were monitored and measured.

The measurements were carried out on a Metravib DMA 150.

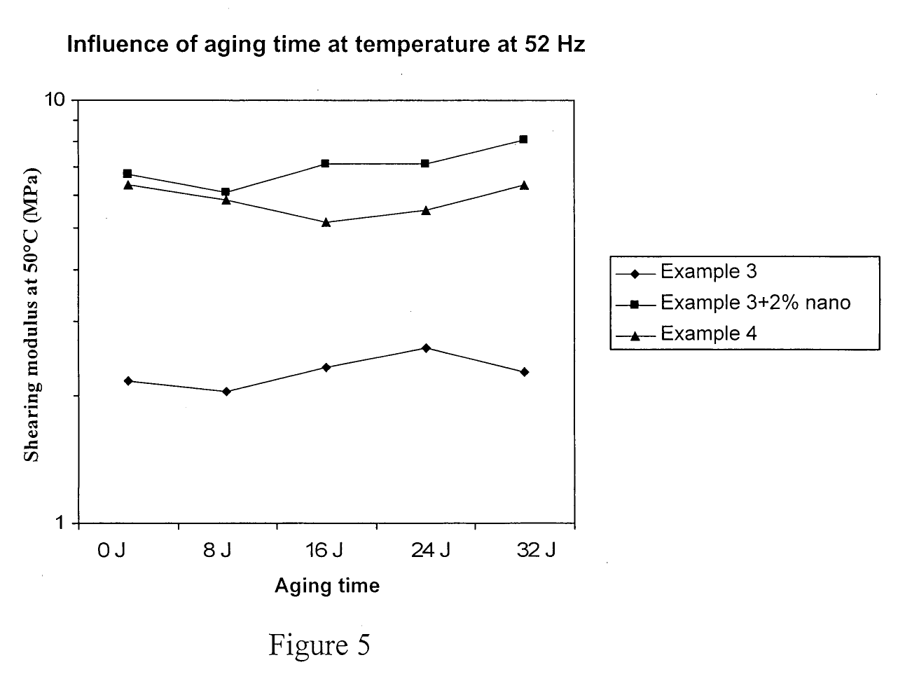

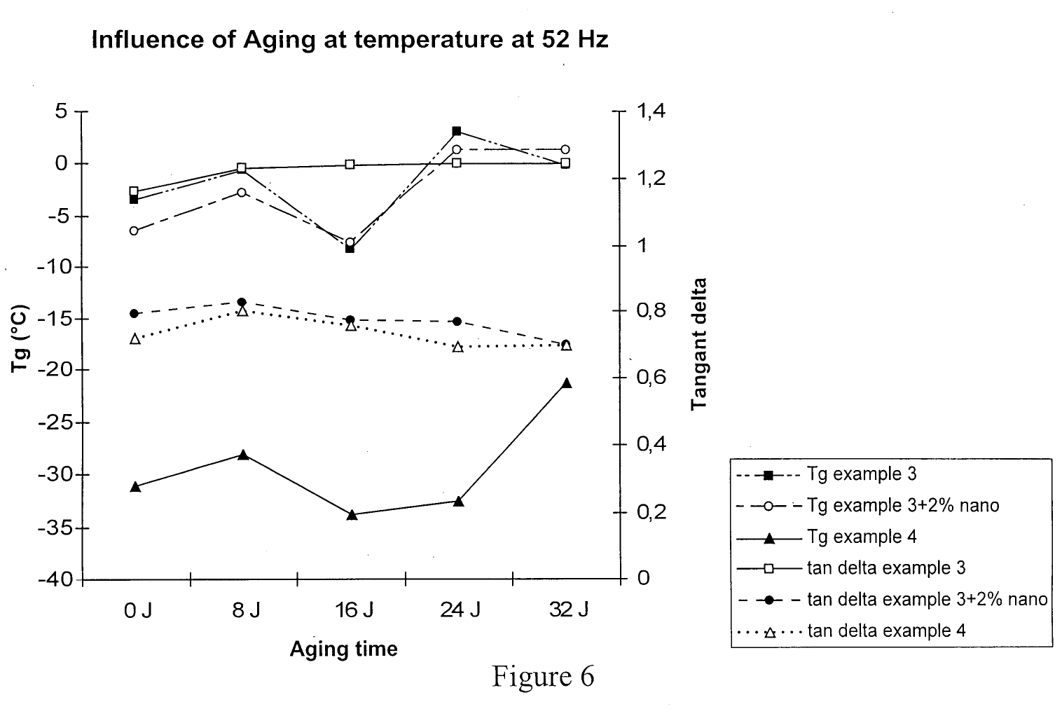

The results are showed in the curves FIGS. 5 and 6.

### Example 7

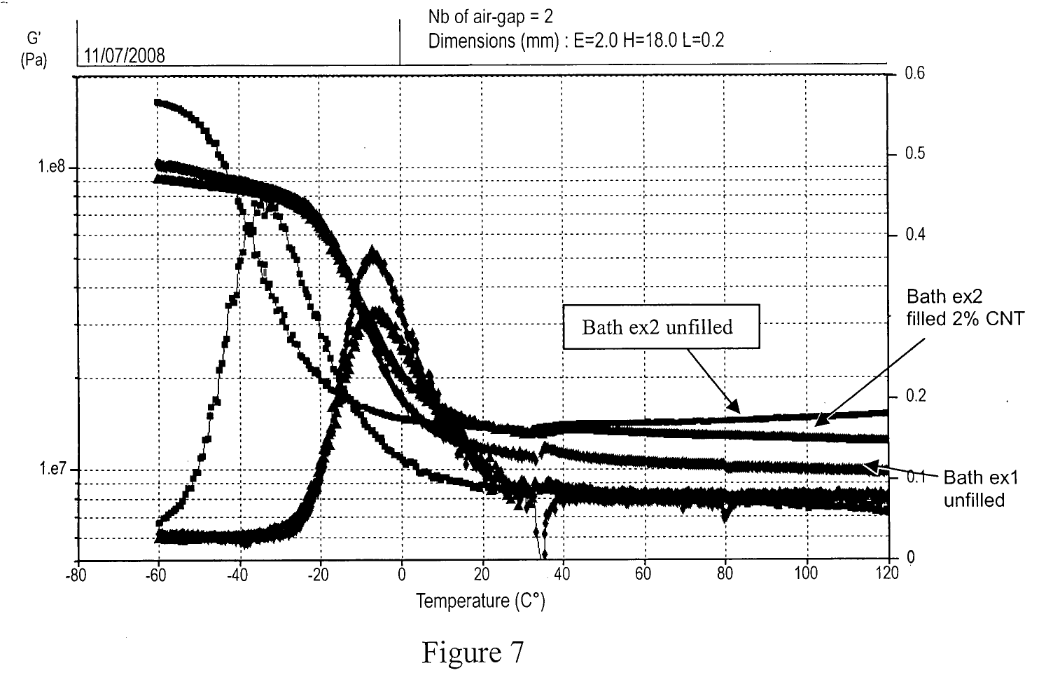

In the same way as before, glass yarns impregnated with RFL solution described in above examples and filled with nanotubes (2%) were characterized under dynamic shear. The results are given in the curves from FIG. 7 that show the unequal behaviors between the RFL families (in both cases, these changes were similar to what can be observed on films); and also between the unfilled formulae and the formulae filled with 2% of CNT.

### Example 8

Monitoring of dynamic mechanical properties in shear of RFL films of unequal nature that are unfilled and filled (formula from Example 2) during static thermal ageing (120° C.) in an oven.

### Trials on Static Thermal Ageing:

These measures have been performed on films that have been in steam room at 100° C. then characterized by DMA with a temperature sweep.

After two months of ageing, a small increase of the G′ modulus for filled films with nanotubes (2%) and no evolution of G′ for the uncharged films.

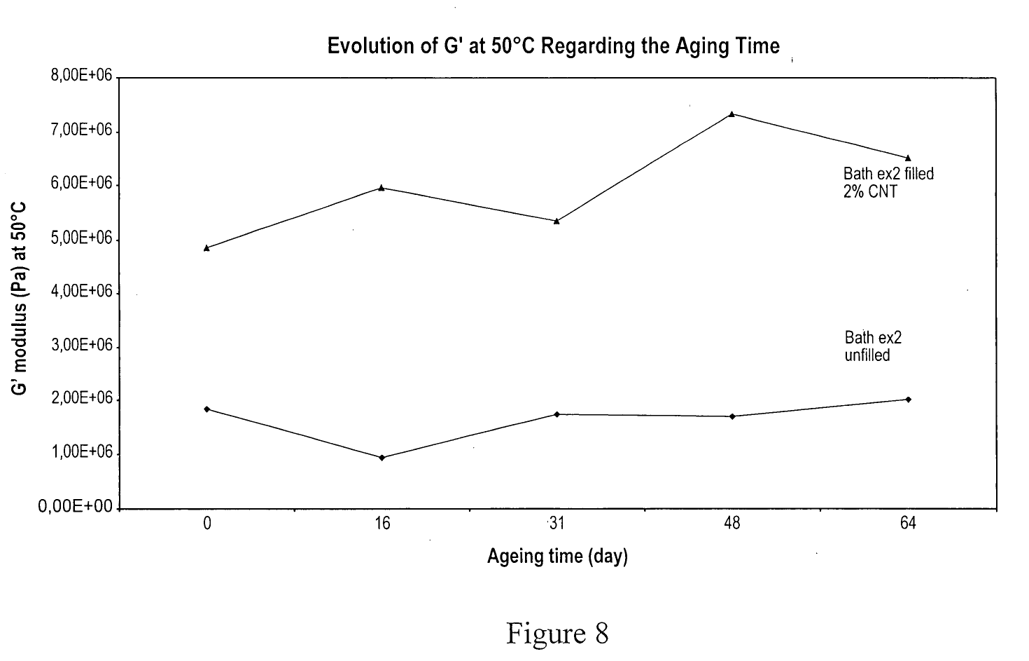

The results are showed in the curves FIG. 8.

### Trials on Dynamic Mechanical Properties

100 Hz-120° C.-without static force-laid displacement 100 μm:

The measures show an important elongation of the unfilled films during this test and a reduced elongation of the filled film, because the CNTs form a second network that support the structure.

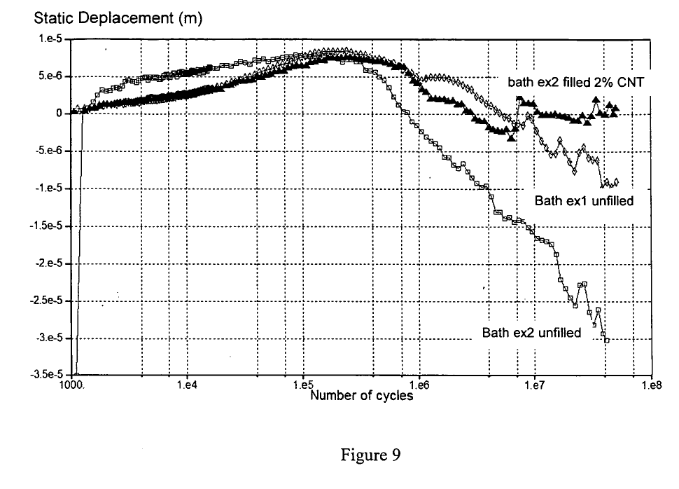

The results are showed in the curves FIG. 9.

1. RFL film or adhesive dip coating comprising carbon nanotubes.

2. Coating according to claim 1, comprising a blend of rubber latex and resorcinol-formaldehyde.

3. Coating according to claim 1, wherein it comprises from 0.5 to 10% by weight of carbon nanotubes, as solids.

4. Coating according to claim 1, wherein the nanotubes are of single-walled or multi-walled type.

5. Coating according to claim 1, wherein the nanotubes have an average diameter between 1 and 100 nanometers.

6. Coating according to claim 1, wherein the nanotubes have an average diameter between 1 and 30 nanometers.

7. Coating according to claim 1, wherein the nanotubes are completely or partly or not at all functionalized.

8. Yarn coated or impregnated with an RFL film or adhesive dip coating according to claim 1.

9. Yarn according to claim 8, wherein the yarn is selected from the group consisting of glass yarns, carbon yarns, aramid yarns, polyester yarns, polyvinyl alcohol yarns, polyamide yarns and rayon yarns.

10. Yarn according to claim 8, comprising, in addition, a coating or topcoat based on a rubber cement in a solvent.

11. Yarn according to claim 10, wherein the coating or topcoat based on a rubber cement in a solvent comprises carbon nanotubes.

12. An article based on a rubber material, reinforced with a yarn according to claim 8.

13. An article according to claim 12, wherein the article is selected from the group consisting of a belt, a tube, a hose, a pipe and a tire.

14. Process for preparing the RFL film or adhesive dip coating according to claim 1, comprising:
a step of preparing an RFL composition;
a step of preparing a dispersion of carbon nanotubes;
a step of mixing, by introducing the dispersion into the composition, in order to obtain a suspension; and
finally, a step of coating, impregnating or depositing the suspension obtained after mixing onto a yarn.

15. Process according to claim 14, wherein in the RFL composition a fraction of resorcinol-formaldehyde resin represents from 2 to 30% by dry weight and a fraction of latex represents from 70 to 98% by dry weight.

16. Process according to claim 14, wherein the step of mixing by introducing the dispersion into the composition, in order to obtain a suspension, is carried out under gentle stirring, using a stirrer that causes a shear rate of less than 300 rpm.

17. Process according to claim 14, wherein the dispersion includes a mixture of water with one or more surfactant compounds.

18. Process according to claim 14, wherein the step of coating, impregnating or depositing the suspension obtained after mixing onto a yarn comprises a splaying step in order to individually impregnate the constituent fibers of the yarn.

19. Process according to claim 18, wherein the step of coating, impregnating or depositing the suspension obtained after mixing onto a yarn is followed by a step of drying and/or crosslinking.

20. Process according to claim 19, further comprising, after the impregnation step, and before the drying step, a step of sizing the coating.

21. Process according to claim 18, further comprising a step of impregnating the yarn, in an adhesive in a solvent medium.

22. A longitudinal reinforcing element comprising a plurality of yarns according to claim 8, configured to be incorporated into an article based on a rubber material.
